(19) United States
(12) Patent Application Publication
(10) Pub. No.: US 2010/0264599 A1
(43) Pub. Date: Oct. 21, 2010

(54) SEAL

(76) Inventors: Rifat Al Chalabi, Cranford, NJ (US); Ophneil Henry Perry, Cranford, NJ (US); John Henry Turner, Ranskill (GB); Stevan Tiepo, Nottingham (GB)

Correspondence Address: YOUNG BASILE, 3001 WEST BIG BEAVER ROAD, SUITE 624, TROY, MI, 48084, US

(21) Appl. No.: 12/764,423

(22) Filed: Apr. 21, 2010

(30) Foreign Application Priority Data
Apr. 21, 2009 (GB) 0906790.1

(51) Int. Cl. F16J 15/34

(52) U.S. Cl. 277/377

(57) ABSTRACT

A seal for sealing together first and second tubular members (12,14) rotatable relative to one another is provided. The seal comprises first and second sealing portions (18, 20) securable respectively to said first and tubular members (12,14) and having respective first and second abutment surfaces (40, 26) slidingly engageable with one another. In response to the application of axial pressure to the first abutment surface (40) through the second abutment surface (26), the abutment surface of the first sealing portion (18) is deflectable axially of the second sealing portion (20) in the direction of the axial pressure to retain the abutment surfaces in sealing contact.

The present invention relates to a seal.

The present invention seeks to provide an improved seal.

Accordingly, the present invention provides a seal for sealing together first and second tubular members rotatable relative to one another, comprising: first and second sealing portions securable respectively to said first and second parts and having respective first and second abutment surfaces slidingly engageable with one another; wherein, in response to the application of axial pressure to said first abutment surface through said second abutment surface, the abutment surface of said first sealing portion is deflectable axially of the second sealing portion in the direction of said axial pressure, thereby to retain said abutment surfaces in sealing contact.

In a preferred embodiment, the resistance of said abutment surface to deflection increases with deflection. The first sealing portion has a diaphragm member with inner and outer radial portions and a through-hole for passage of material between said first and second tubular members; and said abutment surface of said first sealing portion is formed on said radially inner portion.

Preferably, said first and second sealing portions are annular.

The present invention is further described hereinafter, by way of example, with reference to the accompanying drawings, in which:

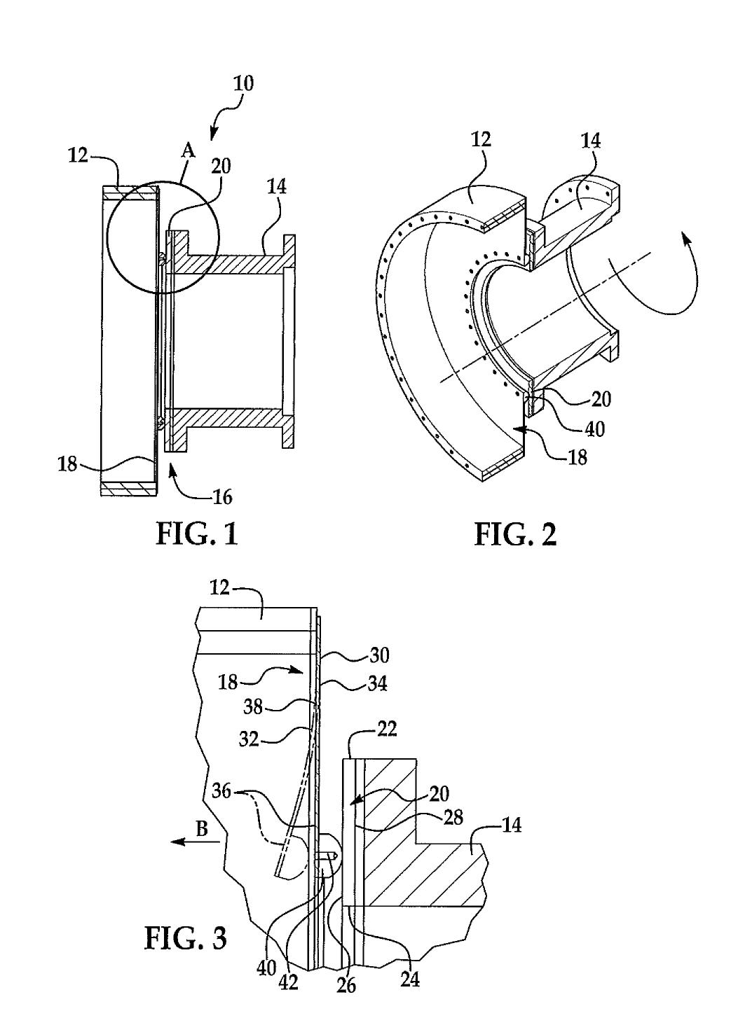

FIG. 1 is a longitudinal section through two tubular members sealed together by a preferred form of seal according to the present invention;

FIG. 2 is a perspective view of the assembly of FIG. 1; and

FIG. 3 is an enlarged view of a portion of the assembly of FIG. 1.

Referring to the drawings, FIG. 1 shows an assembly 10 of two tubular members 12, 14 in the form of pipes or conduits. The pipes are axially aligned and rotatable relative to one another about their longitudinal axes. In this example pipe 14 is rotatable whilst pipe 12 is stationary, although it will be appreciated that either or both pipes may be rotatable and the pipes may rotate in opposite directions. The pipes are intended to carry material such as gases and are axially sealed to one another by a preferred form of seal 16 according to the present invention.

The seal has a first sealing portion 18, which is secured to the first pipe 12 and a second sealing portion 20 secured to the second pipe 14. The sealing portions 18, 20 are preferably annular and are located coaxial with the respective pipe for ease of operation.

FIG. 3 shows an enlargement of the portion A of FIG. 1. As can be seen from FIG. 3, the sealing portion 20 comprises an annular, generally planar ring having radially inner and outer edges 22, 24 and axial surfaces 26, 28, and a through opening through which material can pass. The ring 20 is secured to the outer end of the pipe 14 by way of its axial surface 28 whilst the opposed axial surface 26 serves as an abutment surface for abutting with the first sealing portion 18.

The first sealing portion 18 has an annular member or diaphragm 30 which is generally planar, having axially opposed surfaces 32, 34 and radially inner and outer regions 36, 38. The diaphragm 30 has a through opening through which material can pass. The diaphragm 30 is secured to the end of the pipe 12 at or adjacent its outer end region 38 and carries on its inner end region 36 a flange or abutment 40 facing the abutment surface 26 of the second sealing portion 20. The abutment 40 is generally annular and is secured in place on the diaphragm 30 by securing means such as screws 42. When abutting the abutment surface 26 of the second sealing portion 20, the abutment 40 provides a seal to prevent the escape from the interior of the pipes 12, 14 of material passing through the pipes 12, 14. The diaphragm 30 is formed from a resilient material such as steel and is sufficiently thin such that when axial pressure is applied to the pipe 14 to force the sealing portion 20 against the abutment 40, the latter can deflect in the direction of arrow B, as shown in FIG. 3 in dotted lines, to provide an efficient seal.

The fact that the diaphragm 30 is resilient caters for wear of the abutment 40 caused by rotation of the pipe 14 and the sealing portion 20 relative to the member 12 and sealing portion 18.

The second sealing portion 20 is conveniently made of a hardened material such as ceramic material. This ensures that wear occurs to the abutment 40 which can be easily be replaced,

1. A seal for sealing together first and second tubular members rotatable relative to one another, comprising:
first and second sealing portions securable respectively to said first and second tubular members and having respective first and second abutment surfaces slidingly engageable with one another;
wherein, in response to the application of axial pressure to said first abutment surface through said second abutment surface, the abutment surface of said first sealing portion is deflectable axially of said second sealing portion in the direction of said axial pressure, thereby to retain said abutment surfaces in sealing contact.

2. A seal as claimed in claim 1 wherein the resistance of said abutment surface to deflection increases with deflection.

3. A seal as claimed in claim 1 wherein:
said first sealing portion has a diaphragm member with inner and outer radial portions and a through-hole for passage of material between said first and second tubular members;
and said abutment surface of said first sealing portion is formed on said radially inner portion.

4. A seal as claimed in claim 2 wherein:
said first sealing portion has a diaphragm member with inner and outer radial portions and a through-hole for passage of material between said first and second tubular members;
and said abutment surface of said first sealing portion is formed on said radially inner portion.

5. A seal as claimed in claim 1 wherein the first sealing portion is formed of a resilient material such that axial deflection thereof induces a resilient force acting to return the first sealing portion too its position prior to axial deflection.

6. A seal as claimed in claim 1 wherein the first sealing portion comprises a substantially planar metal disc attached to said first tubular member substantially around its outer edge.

7. A seal as claimed in claim 6 wherein said first sealing portion is made of stainless steel

8. A seal as claimed in claim 1 wherein said first and second sealing portions (18, 20) are annular.
